(19) United States
(12) Patent Application Publication
(10) Pub. No.: US 2004/0068577 A1
(43) Pub. Date: Apr. 8, 2004

(54) Method for controlling a stream of data packets in a packet data communication network

(76) Inventor: Jussi Ruutu, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/450,178

(22) PCT Filed: Dec. 12, 2000
(86) PCT No.: PCT/EP00/12603

(51) Int. Cl. G06F 15/16

(52) U.S. Cl. 709/236; 709/224; 709/247

(57) ABSTRACT

The present invention proposes a method for controlling a stream of data packets in a packet data communication network, the method comprising the steps of: detecting the presence of a predetermined condition in said network, and, in response thereto, shortening at least one data packet within said stream of data packets. Also, the present invention proposes a correspondingly adapted network element in a packet data network.

### FIELD OF THE INVENTION

The present invention concerns a method for controlling a stream of data packets in a packet data communication network and correspondingly adapted network elements.

### BACKGROUND OF THE INVENTION

In recently developing communication networks, communication is increasingly effected on a packet switched basis. This means that data are forwarded from a (first) transmitting communication partner to a (first) receiving communication partner (destination) as data packets which may not necessarily be transmitted immediately and/or consecutively. Stated in other words, data packets from another (e.g. second) transmitting communication partner and/or to another (e.g. second) destination may intermittently be inserted in the data transmitted between the first communication partners.

Such insertions are under control of the communication network, which for example handles the data to be transmitted as so-called “best effort” traffic. This means that data are transmitted to/from a communication partner in case there is traffic capacity available in the network.

In order that a data transmission between respective communication partners is successful, a certain quality of data transmission has to be assured by the network, i.e. network management. To this end, so-called quality of service mechanisms (QoS) have been introduced in the networks.

Examples for packet switched networks are the Internet operated on the basis of the Internet Protocol (IP), an ATM network (ATM=Asynchronous Transfer Mode), GPRS (General Packet Radio Service), a network operated on the basis of TCP/IP (Transmission Control Protocol/Internet Protocol) or the like. The present invention to be described later on is not limited to any of such networks but relates to any kind of packet data communication network. Only for explanatory purposes, however, it is sometimes referred to a specific one of the packet data communication network examples mentioned above.

Current Quality of Service (QoS) mechanisms in Internet, such as for example Differentiated Services or Integrated Services proposed by the IETF (Internet Engineering Task Force), are based on the idea of handling network congestion and quality of service by the means of discarding data packets and/or buffering them.

Generally, quality of Service (QoS) relates to the capability of data networks to transfer data with small enough loss and delay. In practice, current packet data networks, such as for example IP networks or ATM networks, contain QoS mechanisms that control the volume and nature of the transported data traffic. Especially important is the way how network congestion is handled.

In this connection it is possible to distinguish two major principles:

1. Data packets are discarded at the edge (i.e. at the border or at a gateway) of the network early enough when congestion threatens. That is, there exists only a rather high probability that congestion will occur in near future but congestion is not yet present. Then, data packets are discarded so that they will not enter the network expected to experience a congestion in the near future. For example, IP networks based on Integrated Services (IntServ) and several ATM QoS classes utilize mainly this principle.

2. Data packets are discarded inside the core network if congestion arises at some network element. This principle is followed, for example, in the current Best Effort Internet, Differentiated Services (DiffServ) IP networks and UBR based ATM networks (UBR=Unspecified Bit Rate).

It has to be noted that all these principles are based on the idea of discarding data packets. Namely, as stated above, existing QoS mechanisms are mainly based on the idea of controlling data packet loss.

This principle underlying the prior art QoS mechanisms is illustrated in FIG. 1a). As shown in FIG. 1a), two streams of data packets are handled inside a network element. Such a network element may for example be an IP router (in case of an IP network) or an ATM switch (in case of an ATM network). Since the capacity of the network element is not sufficient to handle all the data packets (i.e. network congestion is detected to be present or likely to occur), the traditional packet discarding QoS mechanisms drops (discards) some packets as shown in FIG. 1a).

However, although some applications have been designed to cope with even a large packet loss probability, some other applications can tolerate almost no packet loss.

Consequently, if data losses exceed a certain threshold for an application and may no longer be tolerated, the data stream associated therewith reaches a state in which too many necessary data are lost so that the application will no longer work properly.

Also, if an application which is sensitive to data losses is allocated a higher priority within the network, this implies a higher load for the QoS service, since data streams of different applications will have to be assigned different priorities and the management of the data streams of different priorities becomes more complicated.

### SUMMARY OF THE INVENTION

Hence, it is an object of the present invention to provide a method for controlling a stream of data packets in a packet data communication network which is free from the above drawbacks. Also, it is an object of the present invention to provide a correspondingly adapted network element.

According to the present invention, this object is for example achieved by a method for controlling a stream of data packets in a packet data communication network, the method comprising the steps of: detecting the presence of a predetermined condition in said network, and, in response thereto, shortening at least one data packet within said stream of data packets.

According to further developments of the present invention:

said shortening comprises compressing of at least a part of data of said data packet;

said shortening comprises dropping of at least a part of data of said data packet;

said shortening comprises compressing at least a part of the data of said data packet which remained after dropping of at least a part of data of said data packet;

said part of data of said data packet to be compressed is selected according to a property of said data;

said part of data of said data packet to be dropped is selected according to a property of said data;

a data packet is composed of a plurality of data units, said plurality of data units is partitioned into data groups, each data group being addressable within said data packet;

an address of said data group within said data packet is related to a type of content of data contained in said data group;

said predetermined condition indicates a congestion in said packet data network,

said predetermined condition indicates a coming second predetermined condition; and

said second predetermined condition is a congestion in said packet data network.

Furthermore, according to the present invention, this object is for example achieved by a network element in a packet data network, adapted to carry out the method as set out above.

Stated in other words, according to the present invention, a completely new principle is proposed. Namely, a new QoS mechanism, hereinafter also called “Stripping QoS”, is introduced. The mechanism is substantially based on the idea that instead of discarding the whole data packet, the length of the packet is reduced so that a received packet is shorter than a sent one. This can be accomplished either by discarding/dropping only a part of the payload of a data packet, e.g. a part thereof that carries less important information, or by applying some data compression scheme to a part of the data packet, or by a combination of both.

By virtue of the present invention it is advantageously achievable that

packet data network congestion can be reduced due to traffic volume reduction,

similar advantageous effects as achieved with conventional methods based on packet discarding can be realized,

applications which are sensitive to data losses will work more reliable since only a part of a respective packet is missing,

data streams may be treated in a similar way so that a priority handling of data streams of different applications may be simplified at least from a network point of view,

the performance of applications which can adjust their operation according to the data received even if only part of (initially) sent data (payload) is received, can be improved, and

supplementary functionality to be realized in the network in order to implement the present invention does not exceed the complexity of existing QoS mechanisms but is reduced as compared to existing QoS mechanisms.

### BRIEF DESCRIPTION OF THE DRAWINGS

Still further objects, features and advantages of the present invention will become apparent upon consideration of the accompanying drawings, in which

FIG. 1 illustrates flows of packet data streams via a network element, with FIG. 1a) illustrating the principle underlying the prior art method and FIG. 1b) illustrating the principle underlying the present invention; and

FIG. 2 shows a hierarchical structure of a data packet.

### DETAILED DESCRIPTION OF THE EMBODIMENTS

Hereinafter, the present invention will be described in detail with reference to the drawings.

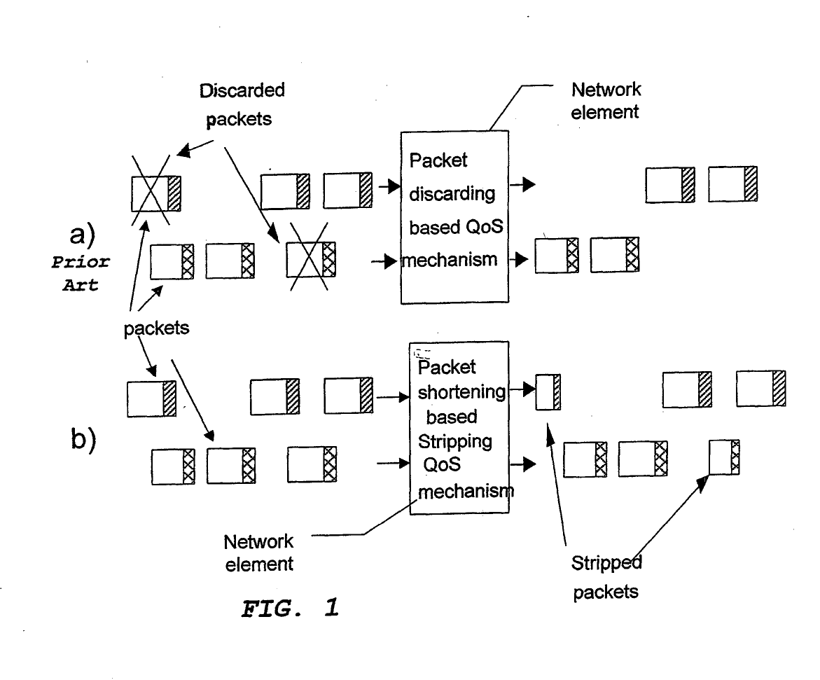

FIG. 1b) illustrates the principle underlying the present invention. As shown in FIG. 1b), two streams of data packets are handled inside a network element. Such a network element may for example be an IP router (in case of an IP network) or an ATM switch (in case of an ATM network). Since the capacity of the network element (and/or network) is not enough to handle all the data packets (i.e. network congestion is detected to be present or likely to occur), the network element shortens at least one data packet within a respective stream of data packets.

It is to be noted that the number of streams of data packets handled by a network element is not limited to two, rather any number of data streams may be handled by a network element as long as the network element is designed to cope with that number of data streams.

The shortening of at least one data packet within a stream of data packets is initiated upon detection of the presence of a predetermined condition in said network. Said predetermined condition indicates a congestion in said packet data network. Note that congestion may be indicated already by a condition/state preceding an actual congested state of the network but which indicates a rather high probability that congestion is likely to occur in the near future. Nevertheless, the predetermined condition may also be the condition of an actual congested state of the network and/or network element. Generally, any condition suitable to indicate that the packet data network is or may be overloaded (congested) is suitable for the purpose of the present invention. However, as only the detection as such is relevant for initiating the method according to the present invention, the present specification does not focus on an evaluation of network states leading to a detection of such a predetermined condition.

As mentioned above, within said stream of data packets at least one data packet is shortened. That is, only one, more than one, or even all data packets may be subjected to shortening according to the need. The amount of data packets to be shortened within a data stream depends, for example, on the degree of congestion detected, and/or is predetermined for a data stream (e.g. based on the transmitter and/or destination of the data, and/or based on the type (content) of data transmitted and/or the length of the data packets and/or some classification of the data stream).

Heretofore, a description has only focused on the shortening of one or more data packets as such. Shortening of data packets, however, may be effected in several ways.

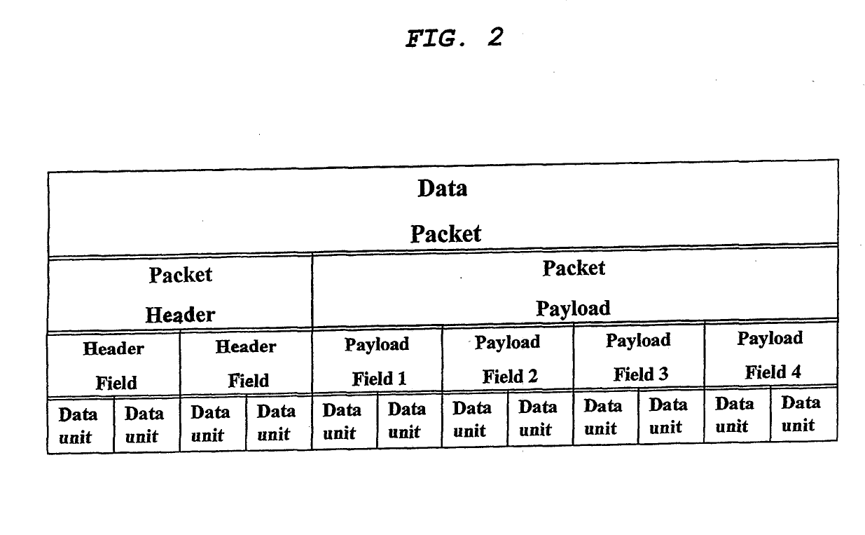

In this connection and to enhance the clarity of the explanatory description, it is referred to FIG. 2 which shows a hierarchical structure of a data packet. The illustrated structure is intended to cover any kind of data packet and is not limited to a specific kind of data packet.

As shown in FIG. 2, a data packet consists of a packet header and a packet payload. The packet header includes management information such as transmitting party information (e.g. address), destination (receiving party) address, type of payload data, or the like. The packet payload includes the data transmitted for “use” at the receiving party side (e.g. speech data or the like). Also, the packet header comprises plural header fields, while likewise the packet payload comprises plural payload fields. Note that the number of header and/or payload fields has arbitrarily been chosen for explanatory purposes only. The number of fields in a packet conforming to an existing standard such as an ATM packet (ATM cell) may differ from the illustrated basic example. Each field in turn is composed of plural data units. A data unit may be a byte or a bit or a set of plural bits (different from a byte as a set of eight bits). Also, the fields need not necessarily be composed of an identical number of data units. Thus, stated in other words, a data packet is composed of a plurality of data units (bits and/or bytes), said plurality of data units is partitioned into data groups such as fields (fields being in turn grouped to form a packet header and packet payload), so that each data group is addressable within said data packet. Also, an address of such a data group within said data packet is related to a type of content of data contained in said data group (e.g. header information for communication management and or payload information). Also within the packet payload, the payload fields may contain different types of content of data contained in a respective payload field. The different types of data may be attributed different importance. For example, there may be a mapping of the address of a data group to an importance of the data of said data group. Or the importance of data group may be indicated by some other way, for example by some information carried in the data packet. For example, the data group addressed by the highest address number (of the packet as well as of the payload) may be attributed the least importance, while the data group with the lowest address number following the header field addresses may be attributed the highest importance (of the data within the payload). For the example in FIG. 2 this means that payload field 4 has the lowest importance while payload field 1 has the highest importance. Note that the data in the header fields may always be attributed the highest importance of all data in the packet.

For example only, it is referred to an ATM cell. An ATM cell consists of five byte header information and 48 bytes payload information. The header in turn consists of a Generic Flow Control (GFC) information of 4 bit within the first byte, a Virtual Path Identifier (VPI) of 8 bit within the first and second byte, a Virtual Channel Identifier (VCI) of 16 bit from the second to the fourth byte, a Payload Type (PT) information (2 bits) and a Cell Loss Priority (CLP) information (2 bits) filling up the fourth byte, and a header error Control information field (8 bits) as the fifth byte of the header and the overall ATM cell.

Now, referring back to different ways of shortening a data packet, a data packet may be shortened by compressing at least a part of data of said data packet, by dropping (removing and/or discarding) at least a part of data of said data packet, or by a combination of the above. That is, by compressing at least a part of the data of said data packet which remained after dropping of at least a part of data of said data packet. The part of data of the data packet to be subjected to shortening, i.e. to be compressed or dropped, is selected according to the type of data. Stated in other words, less important data parts of a packet are dropped/compressed first. The importance of the data within the packet is derivable from the address (i.e. position) of the data within the packet. Generally, as criteria for selecting the part of a data packet to be subjected to shortening (i.e. dropping or compressing) any property of the data within the packet such as type of content, length, position in data packet, etc. is applicable.

It is to be noted that the part or parts subjected to shortening (i.e. removal/dropping or compression) may reside in any part of the packet, i.e. within the payload, the header or any other part of a data packet such as a tail (not shown in FIG. 2).

Also, in some cases it is also possible that the entire packet payload is dropped so that only the packet header or even only a part of the packet header is forwarded to the destination. This may be beneficial for applications which could make use of an indication about network congestion. For example, a missing payload could be interpreted at the receiving communication partner that the network is congested and the receiving communication partner could (in a bi-directional communication) adapt its transmission behavior by sending less data, compressing it somehow else, or the like, so that already at the stage of data creation traffic is reduced and network congestion is supported to be avoided.

In case the importance of data within the packet payload is not mapped to the data address within the packet, the header could be modified by including a piece of information indicating which payload field or fields could be removed or compressed in case of the detection of the predetermined condition, i.e. congestion occurred or likely to occur. For four payload fields as shown in the example of FIG. 2, an indication comprising 2 bits in the header would be sufficient for this purpose. Such information or the storing of the information to the address mapped to the importance of the information would however have to be effected at the origin of the data, i.e. by the application at the transmitting side.

Herein before, the present invention has been described in a general way and without focus on a specific packet data communication network and the data format used therein. Therefore, subsequently some specific examples of an implementation of the present invention will be given in rough outline, while it is to be noted that these examples are provided only to further illustrate and clarify the invention without any limitation to the scope.

### 1^{st} EXAMPLE

There exist many applications, especially those aimed at running over wireless links. These applications, such as many voice and video codecs, pack data to packets or frames in such a way that the payload contains information of varying importance. For example, certain speech codecs produce speech frames that contain bits of different level of importance. Thus, with the present invention being adopted in such applications, over the wireless interface at least the most important bits could be transmitted successfully by, e.g., applying different kind of error coding to different parts of the speech frame or by dropping the least or less important data.

Also, it should be noted that in some cases applications may benefit from an indication that there exists network congestion. For example, adaptive speech codecs can change their operation so that they already produce speech frames with shorter length.

### 2^{nd} EXAMPLE

Another example is Transmission Control Protocol (TCP).

Even though it is not an application, it utilizes the services of IP transport network. An essential part of TCP is the flow control system that is based on cumulative acknowledgements (ACK). One feature of TCP is that ACKs can be piggybacked, i.e., TCP segments carrying data may contain an embedded acknowledgement for a TCP connection transporting data in the reverse direction. In this case the (backward direction) acknowledgement may be more important than the (forward direction) data so that the flow control performs better.

TCP may thus benefit from the method according to the present invention also referred to as “Stripping QoS”. This can be accomplished, for example, by implementing to IP routers (as network elements) a feature that in the case of congestion as a predetermined condition, the TCP payload (of the forward direction) is (fully) removed while the piggybacked acknowledgement is still forwarded (i.e. a TCP header with no data annexed to it is transmitted).

It is obvious that for such kind of applications it is advantageous to receive even a part of the payload rather than loosing the whole payload. For example, while the quality of a voice over IP application would suffer, the effect of partially lost payload is still smaller than problems caused by the fully lost payload.

### 3^{rd} EXAMPLE

When utilizing the present invention with Differentiated Services networks, it is possible to introduce a new Differentiated Services Per Hop Behavior (PHB) class. This class will consist of one or more PHBs that support “Stripping QoS” according to the proposed invention.

For example, let's say that a DiffServ codepoint (DSCP) is reserved for “Stripping PHB”. When a DiffServ core router supporting Stripping PHB receives a packet marked with this DSCP during network congestion, some less important information is removed from and/or compressed in the packet in order to reduce congestion. It is also possible that there exists a set of PHBs so that packets with different PHBs will face stripping of data from different parts of the packets. For example, one DSCP can be received for an audio packet while the second is used with video packets. Thus, the part or parts of data of said data packet to be dropped is/are selected according to a type of content (as a property) of said data. Also different DSCPs may indicate different ways or degrees to apply the method according to the present invention, i.e. Stripping QoS.

### 4^{th} EXAMPLE

The present invention can also be used with IETF's Integrated Services. For example, when using the “Stripping QoS” method according to the present invention with Guaranteed Services, the policing function as a network element at the edge of the network starts to strip packets (drop only parts thereof or compress at least part thereof, or a combination of both) instead of entirely discarding them when the traffic profile (for example maximum bit rate) of the traffic source (transmitter) has been exceeded.

### 5^{th} EXAMPLE

IP version 4 has the possibility to add an Options-field to the IP packet header. In IP version 6 about the same functionality is handled by so-called Extension Headers. It is possible to define either an Extension Header or Options field supporting the proposed method, i.e. “Stripping QoS”. In this case, the field or header contains information about what parts of the IP packet can be stripped. This kind of system may be used together with DiffServ but it is not necessary.

As the specific terminology referred to herein above in connection with the 1^{st} through 5^{th} Example is considered to be known to skilled persons, a detailed definition thereof is considered to be dispensable here. Rather, it is referred to the respective pertinent definitions as given by the IETF, to the definitions of TCP, IP and the like.

Accordingly, as has been described herein above, the present invention proposes a method for controlling a stream of data packets in a packet data communication network, the method comprising the steps of: detecting the presence of a predetermined condition in said network, and, in response thereto, shortening at least one data packet within said stream of data packets. Also, the present invention proposes a correspondingly adapted network element in a packet data network.

Although the present invention has been described herein above with reference to its preferred embodiments, it should be understood that numerous modifications may be made thereto without departing from the spirit and scope of the invention. It is intended that all such modifications fall within the scope of the appended claims.

1. A method for controlling a stream of data packets in a packet data communication network, the method comprising the steps of:
detecting the presence of a predetermined condition in said network, and, in response thereto,
shortening at least one data packet within said stream of data packets.

2. A method according to claim 1, wherein
said shortening comprises compressing of at least a part of data of said data packet.

3. A method according to claim 1, wherein
said shortening comprises dropping of at least a part of data of said data packet.

4. A method according to claim 3, wherein
said shortening comprises compressing at least a part of the data of said data packet which remained after dropping of at least a part of data of said data packet.

5. A method according to claim 2 or 4, wherein
said part of data of said data packet to be compressed is selected according to a property of said data.

6. A method according to claim 3, wherein
said part of data of said data packet to be dropped is selected according to a property of said data.

7. A method according to claim 1, wherein
a data packet is composed of a plurality of data units, said plurality of data units is partitioned into data groups, each data group being addressable within said data packet.

8. A method according to claim 7, wherein
an address of said data group within said data packet is related to a type of content of data contained in said data group.

9. A method according to claim 1, wherein
said predetermined condition indicates a congestion in said packet data network.

10. A method according to claim 1, wherein
said predetermined condition indicates a coming second predetermined condition.

11. A method according to claim 10, wherein said second predetermined condition is a congestion in said packet data network.

12. A network element in a packet data network, adapted to carry out the method according to any of claims 1 to 11.
